(19) United States
(12) Patent Application Publication
(10) Pub. No.: US 2008/0000349 A1
(43) Pub. Date: Jan. 3, 2008

(54) Air filter monitor

(76) Inventors: Robert J. Pape, Ponte Vedra Beach, FL (US); Jeffrey Bowman, Atlantic Beach, FL (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/477,093

(22) Filed: Jun. 28, 2006

(51) Int. Cl. B01D 46/46

(52) U.S. Cl. 95/23; 96/422

(57) ABSTRACT

An air filter monitor (10) and method of utilizing such to monitor an air filter is disclosed wherein the monitor has a housing (11), an air flow detector (12) with accompanying electrical circuit (13), and a mounting strap (22) which is configured to be secured to a conventional air vent grill of a heating, ventilation and air conditioning system. The air flow detector includes a freely rotating impeller and a sensor (30) which senses the rotational speed of the impeller (29). The electrical circuit also includes a central processing unit (CPU) (32), a battery source (33), a calibrating switch (35), and a light indicator (36). The CPU includes memory for retaining an initial airflow velocity, and means for comparing the current airflow velocity with the initial airflow velocity. The CPU compares the current airflow velocity to the initial airflow velocity and actuates the light should a threshold drop in airflow velocity be reached.

This invention relates to monitors which sense the condition of an air filter for a heating, ventilation and air conditioning system.

### BACKGROUND OF THE INVENTION

The air return of most heating, ventilation and air conditioning (HVAC) systems is provided with an air filter to remove airborne dust and other airborne contaminants that could clog and/or cover the coils of the evaporator or heating element of the HVAC system. These air filters become clogged with filtered contaminants and must be periodically cleaned or replaced in order to avoid a decrease in air conditioning efficiency.

Accordingly, it is seen that a need exists for a monitor for indicating when an HVAC filter should be replaced. It thus is to the provision of such that the present invention is primarily directed.

### SUMMARY OF THE PRESENT INVENTION

In a preferred form of the invention, a filter monitor comprises an airflow velocity sensor, comparing means for comparing a sensed first airflow velocity to a subsequently sensed second airflow velocity, and an indicator coupled to the comparing means and actuated by the comparing means upon reaching a preselected airflow velocity threshold level.

In another preferred form of the invention, a method of monitoring the need to replace an air filter of a ventilation system comprising the steps of sensing an initial airflow velocity associated with a clean air filter, sensing a current airflow velocity associated with a current time period, comparing the sensed initial airflow velocity to the sensed current airflow velocity, and initiating an indicator should the comparison reach a predetermined threshold level.

### BRIEF DESCRIPTION OF THE DRAWINGS

FIG. 1 is a perspective view of a filter monitor in a preferred form of the invention.

FIG. 2 is a perspective view of the filter monitor of FIG. 1.

FIG. 3 is a schematic wiring diagram of the filter monitor of FIG. 1.

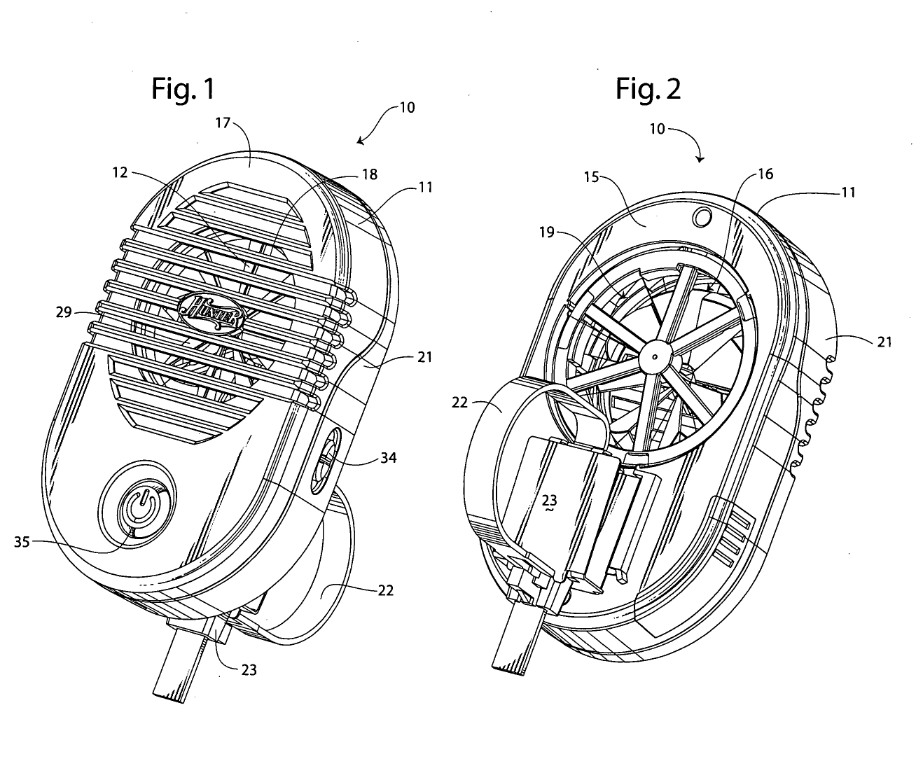

### DETAILED DESCRIPTION

With reference next to the drawings, there is shown an air filter monitor 10 in a preferred form of the invention. The air filter monitor 10 includes a housing 11 and an air flow detector 12 with accompanying electrical circuit 13 mounted to the housing 11.

The housing 11 has a rear wall 15 with an air inlet 16 therethrough, a front wall 17 with an air outlet 18 therethrough, and a channel 19 extending between air inlet 16 and air outlet 18. The front wall 17 and rear wall 15 are spanned by side walls 21. The housing 11 also includes a flexible strap 22 which may be looped back and secured to a strap lock 23. The strap 22 is configured to be secured to a conventional air vent grill of a heating, ventilation and air conditioning system. It should be understood that other conventionally known devices may be utilized to hold the housing to a vent grill, such as opposing hooks, flanges, screws, hook and loop type fasteners, adhesives, adhesive tapes, brackets and the like.

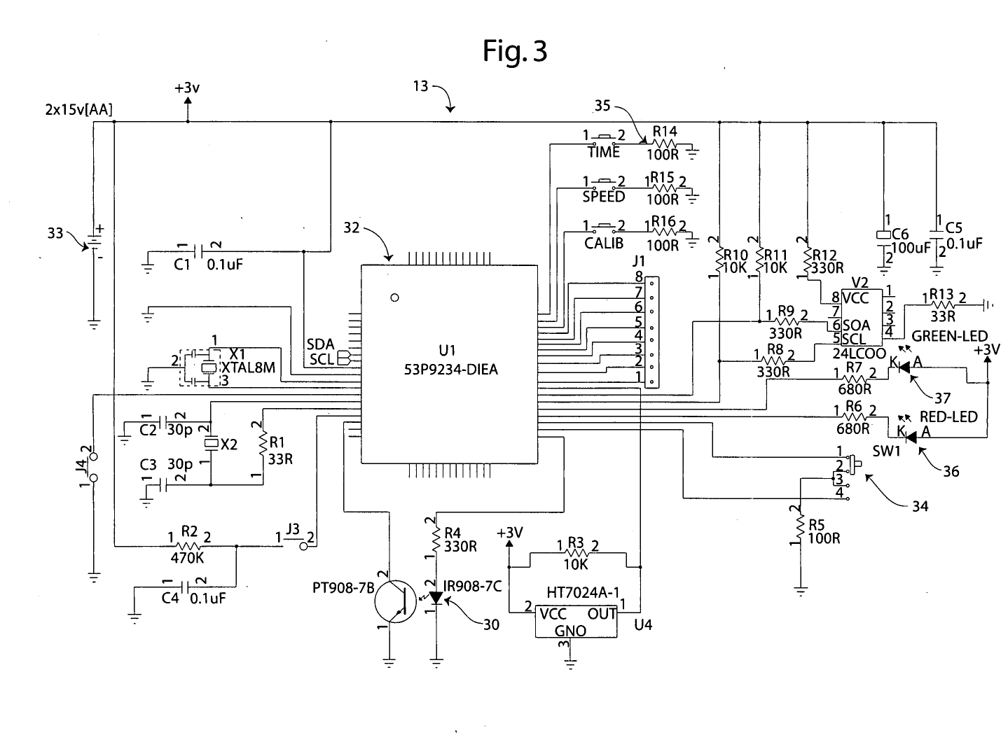

The air flow detector 12 includes a freely rotating impeller or fan blade 29 and a sensor 30 which senses the rotational speed of the impeller 29. The sensor 30 is preferably a photoelectric sensor such as an IR transmitter and receiver. The electrical circuit 13, coupled to the sensor 30, includes a central processing unit (CPU) 32, a battery source 33, a three positional timing switch 34, a calibrating switch 35, a red LED light indicator 36, and a green LED light indicator 37. The light indicators 36 and 37 may be positioned below a translucent portion of the calibrating switch 35, so that the light therefrom shines through the translucent portion so as to be viewable. The CPU includes memory for retaining an initial airflow velocity, means for comparing the current airflow velocity with the initial airflow velocity, and means for directing an electrical current to the light indicators 36 and 37. The complete circuitry is shown in detail in FIG. 3.

In use, an operator mounts the monitor 10 to a conventional HVAC exit vent by passing the strap 22 through a portion of the exit vent grill and locking the strap 22 onto the strap lock 23. The mounting of the monitor allows the airflow from the exit vent during the operation of the HVAC system to be directed through housing channel 19, thereby causing the rotation of impeller 29. The rotational speed of the impeller is dependent upon the velocity of the airstream. As used herein, the term velocity may be equated with airflow volume or cubic feet per minute (cfm). Once the monitor 10 is properly positioned upon the exit vent and with the HVAC operating to create an airflow through the system, the calibrating switch 35 is actuated by the operator. The actuation of the calibration switch 35 causes the CPU 32 to set or reset a commencement time and to store in memory the velocity of the airflow passing from the exit vent and through the monitor 10, determined through the rotational speed of the impeller by sensor 30. The initial airflow velocity, or any common representation thereof as for example the rotational speed of the impeller, is stored within the CPU 32 memory as an initial baseline airflow velocity intended to reflect the velocity associated with the condition of a new, unclogged air filter. To establish an accurate baseline airflow velocity the CPU 32 may utilize an average rotational speed over several seconds to minimize sensed variations in the airflow which may result in an inaccurate baseline airflow velocity.

The monitor remains mounted upon the exit vent over an extended period of time during which time it constantly monitors the velocity of the airflow passing from the exit vent and through the monitor. The timing period or interval period during which the airflow velocity is actually tested, may be for example purposes, one second during every minute. It should be understood however that this period of time may be increased or decreased according to the manufacture's desire of monitoring accuracy and battery life. Should the sensed current airflow velocity determined by the rotational speed of the impeller drop below a preselected threshold lever, for instance a drop in airflow velocity of 25% or more, i.e., 75% or less, of the initial airflow velocity, the CPU 32 energizes the red LED light indicator 36. The illumination of the red LED light indicator 36 alerts the operator to the restricted airflow level resulting from the clogging of the air filter, and therefore the need to replace the air filter.

Once the HVAC system air filter is replaced, the operator may once again actuate the calibrating switch in order to reinitiate the monitor with a new air velocity baseline.

It should be understood that the monitor establishes a baseline airflow velocity which may be unique to that particular exit vent. However, as the monitor senses the airflow associated with that vent and constantly compares the currently sensed airflow relative to the previously established baseline airflow associated with that particular vent, the monitor can be utilized with any vent within the HVAC system regardless of its airflow velocity, so long as the monitoring vent remains constant. In other words, the monitor may be utilized in conjunction with an exit vent that has a high airflow as well as an exit vent that has a low airflow, as the baseline is established for each exit vent on an individual basis and all comparisons are made with regard to a single vent which established the relevant initial baseline.

The monitor CPU 32 may also be programmed to energize the red LED light indicator 37 upon the reaching of a pre-selected time period associated with the three positional time switch 34. For instance, the time switch 34 may have a zero position, a three-month position and a six-month position. If the switch is moved to the six-month position the CPU energizes the red LED light indicator 37 six months after the actuation of the calibrating switch. This provides the operator with an alert that the filter has been in place for six months and therefore may in need of inspection regardless of the sensed airflow. The monitor may utilize both the time sequence established through the timing switch 34 and the change in the airflow velocity sensed by airflow detector 12, thus providing an alert predicated on either the passage of time or the restriction in airflow through the filter.

It should be understood that the airflow velocity is preferably represented and stored as simply the rotational speed of the impeller. However, equivalent representations of the velocity may be determined and stored in any known manner. Any sensing mechanism the operation of which is based upon airflow may be utilized as an alternative to the impeller, such as a moveable flap and sensor measuring the relative positions of the flap, a pressure gauge, or the like.

It should also be understood that the CPU may compare the current airflow velocity to the initial or baseline airflow velocity and then determine if it has reached a threshold level, or calculate a threshold level from the initial airflow velocity and compare the current airflow velocity to that threshold level. The manner in which the algorithm compares the initial velocity to the current velocity is not critical to the present invention. As such, as used herein a comparison of the airflow velocities is not predicated upon the timing or storing of the actual calculations by the CPU and all such comparisons are equivalences regardless of the actual sequence of the calculations and comparisons. For example, the CPU may store the initial airflow velocity directly or store a calculated threshold level of the initial airflow velocity for comparison purposes with the current airflow velocity at a later time.

It should be understood that optionally the monitor may be mounted to the return vent of a HVAC system. Also, any audio or visual indicator may be used as an alternative to the light shown in the preferred embodiment. Additionally, while the preferred embodiment illustrates a 25% drop as being a threshold level, other reasonably desired velocity reductions may be utilized, a determination of which is dependent upon the limit on the amount of air filter clogging, and resulting airflow restriction, prior to initiating an alert.

It thus is seen that a monitor is now provided that provides an indication that a HVAC filter is in need to attention. It should be understood that many modifications may be made to the specific preferred embodiment described herein, in addition to those specifically recited, without departure from the spirit and scope of the invention as described by the following claims.

1. A filter monitor comprising,
an airflow velocity detecting device which generates a representation of detected airflow velocities, initial airflow velocity memory for storing a representation of an initial airflow velocity sensed by said airflow velocity detecting device, and comparing means for comparing the represented initial airflow velocity stored within said initial airflow velocity memory to the represented current airflow velocity sensed by said airflow velocity detecting device and indicating a condition met wherein the current represented airflow velocity reaches a threshold level of the initial represented airflow velocity stored within the initial airflow velocity memory,
whereby the current airflow representation is periodically compared to an initial airflow representation to determine if it has reached a preselected threshold level of the initial airflow which indicates restricted airflow through the filter.

2. The filter monitor of claim 1 wherein said airflow velocity detecting device comprises an impeller and a sensor which senses the rotational speed of said impeller.

3. The monitor of claim 1 further comprising a vent mount, whereby the vent mount enables the monitor to be mounted directly to a ventilation system vent grill.

4. A filter monitor comprising,
a housing;
an impeller mounted to said housing;
an impeller rotational speed sensor;
a processing unit which compares a current impeller rotational speed provide by said speed sensor to an initial impeller rotational speed provided by said speed sensor to determine if a threshold level condition has been reached; and
an alert coupled to said processing unit which provides an alert signal when the threshold level condition is met.

5. The monitor of claim 4 wherein said housing has a channel there through and wherein said impeller is mounted within said channel.

6. The monitor of claim 4 wherein said processing unit includes memory for storing an initial impeller rotational speed.

7. The monitor of claim 4 further comprising a vent mount coupled to said housing, whereby the vent mount enables the monitor to be mounted directly to a ventilation system vent grill.

8. A filter monitor comprising,
an airflow velocity sensor;
comparing means for comparing a sensed first airflow velocity to a subsequently sensed second airflow velocity; and
an indicator coupled to said comparing means and actuated by said comparing means upon reaching a preselected airflow velocity threshold level based upon the sensed first airflow velocity.

9. The filter monitor of claim 8 wherein said airflow velocity sensor comprises an impeller and a sensor which senses the rotational speed of said impeller.

10. The filter monitor of claim 8 wherein said comparing means includes initial airflow velocity memory for storing a representation of an initial airflow velocity sensed by said airflow velocity detecting device, and current airflow velocity memory for storing a representation of a current airflow velocity sensed by said airflow velocity detecting device.

11. The monitor of claim 8 further comprising a vent mount, whereby the vent mount enables the monitor to be mounted directly to a ventilation system vent grill.

12. A method of monitoring the need to replace an air filter of a ventilation system comprising the steps of:
(a) sensing an initial airflow velocity associated with a clean air filter;
(b) sensing a current airflow velocity associated with a current time period;
(c) comparing the sensed initial airflow velocity to the sensed current airflow velocity;
(d) initiating an indicator should the comparison made in step (c) reach a predetermined threshold level.
